(19) United States
(12) Patent Application Publication
(10) Pub. No.: US 2019/0062584 A1
(43) Pub. Date: Feb. 28, 2019

(54) COATING COMPOSITION FOR PROTECTING METAL SURFACE

(71) Applicant: GHI CORPORATION, Ulsan (KR)

(72) Inventor: Jin-Hyun NAM, Ulsan (KR)

(21) Appl. No.: 15/683,306

(22) Filed: Aug. 22, 2017

(51) Int. Cl. C09D 109/06; C09D 5/32; C09D 7/12

(52) U.S. Cl. CPC C09D 109/06; C08K 5/06; C09D 7/1233; C09D 5/32

(57) ABSTRACT

Disclosed is a coating composition for protecting a metal surface, including styrene-ethylene-butylene-styrene rubber, a solvent and an additive. The coating composition can inhibit scratching or corrosion when applied on the surface of a metal such as a flange and is effective at enabling easy peeling of a coating film even when the coating film is intended to be peeled in order to perform a welding process or the like, and moreover, a resultant coating film does not tear but is easily peeled even when removed after long-term storage.

### BACKGROUND

### 1. Technical Field

The present disclosure relates to a coating composition for protecting a metal surface, and more particularly to a coating composition for protecting a metal surface, which may be used to inhibit scratching or corrosion when applied on the surface of a metal such as a flange and is effective at enabling easy peeling of a coating film even when the coating film is intended to be peeled in order to perform a welding process or the like, and moreover, in which the coating film does not tear but is easily peeled even when removed after long-term storage.

### 2. Description of the Related Art

As a coating agent, there is a demand for a coating composition that is able to form a coating film having characteristics such that it is capable of realizing designability of various substrate surfaces and is also capable of preventing deterioration of the substrate surface.

Particularly in recent years, required is the production of a coating agent for forming a coating film having chemical resistance, capable of preventing deterioration of a substrate due to contact with acid rain or chemicals such as detergents, in addition to water resistance and solvent resistance.

In many cases, the coating agent has been mostly used for protecting the surface of a plastic product, which tends to deteriorate due to contact with an organic solvent or a chemical. However, due to an increase in the demand for metals, demand for a coating agent for protecting the surface of a metal substrate including a steel plate is also increasing. In addition to the properties such as solvent resistance listed above, high corrosion resistance and chemical resistance are required in order to prevent stripping or swelling of the coating film due to corrosion of the metal substrate.

Particularly in the steel industry where the surface of a coating film formed on the surface of a metal substrate is often cleaned using an alkaline detergent or the like, chemical resistance is regarded as very important because it is able to prevent deterioration of the metal substrate and the stripping or dissolution of the coating film caused by the detergent.

Conventionally, in order to satisfy the above-mentioned characteristics, mainly useful is an aqueous coating agent containing a vinyl-urethane-based copolymer in which the chain of a vinyl-based polymer and the chain of a urethane-based polymer are bonded via a connector having a bond between a silicon atom and an oxygen atom. In this coating agent, the crosslinking density in the particles comprising the vinyl-urethane-based copolymer is comparatively high, making it difficult to fuse particles upon film formation. Consequently, a coating film that is uniform and dense cannot be formed, and effects of preventing the corrosion or deterioration of a metal substrate are insignificant.

Moreover, conventional attempts have been made to coat the surface of a metal with a coating solution obtained by mixing a styrene-butadiene rubber (SBR) solution with an antioxidant in order to prevent scratching or corrosion. In this case, however, the coating film formed using the styrene-butadiene rubber solution may be easily torn during the removal of the formed coating film, and thus the removal process thereof is not efficient.

### CITATION LIST

### Patent Literature

(Patent Document 0001) Korean Patent No. 10-0553401 (Feb. 10, 2006).

(Patent Document 0002) Korean Patent No. 10-0819915 (Mar. 31, 2008).

### SUMMARY OF THE INVENTION

Accordingly, the present disclosure has been made keeping in mind the problems encountered in the related art, and an aspect of the present disclosure is to provide a coating composition for protecting a metal surface, which may be used to inhibit scratching or corrosion when applied on the surface of a metal such as a flange and is effective at enabling easy peeling of a coating film even when the coating film is intended to be peeled in order to perform a welding process or the like, and moreover, in which the coating film does not tear but is easily peeled even when removed after long-term storage.

Therefore, the present disclosure provides a coating composition for protecting a metal surface, comprising styrene-ethylene-butylene-styrene rubber, a solvent and an additive.

Preferably, the amount of the styrene-ethylene-butylene-styrene rubber is 100 parts by weight, the amount of the solvent is 325 to 475 parts by weight and the amount of the additive is 2.5 to 25 parts by weight.

More preferably, the solvent comprises at least one selected from the group consisting of toluene, xylene and methyl ethyl ketone.

Much more preferably, the additive comprises a colorant and a defoaming agent.

Even more preferably, based on 100 parts by weight of the styrene-ethylene-butylene-styrene rubber, the coating composition of the disclosure further comprises 20 to 35 parts by weight of a UV blocker containing titanium dioxide.

Still even more preferably, based on 100 parts by weight of the styrene-ethylene-butylene-styrene rubber, the coating composition of the disclosure further comprises 85 to 100 parts by weight of a swelling inhibitor containing dimethylether.

According to the present disclosure, a coating composition for protecting a metal surface can inhibit scratching or corrosion when applied on the surface of a metal such as a flange and is effective at enabling easy peeling of a coating film even when the coating film is intended to be peeled in order to perform a welding process or the like, and moreover, in which the coating film does not tear but is easily peeled even when removed after long-term storage.

### BRIEF DESCRIPTION OF THE DRAWINGS

FIG. 1 is of photographs showing the results of measurement of removal efficiency after 24 hr hours of coating films formed of coating compositions for metal surface protection of Example 1 and Comparative Example 1;

FIG. 2 is of photographs showing the results of measurement of removal efficiency after one week of coating films formed of coating compositions for metal surface protection of Example 1 and Comparative Example 1;

FIG. 3 is of photographs showing the results of measurement of removal efficiency after 30 days of coating films formed of coating compositions for metal surface protection of Example 1 and Comparative Example 1; and

FIG. 4 is of photographs showing the flanges coated with the coating compositions of Examples 1 and 2 after a salt spray test.

### DESCRIPTION OF THE EXEMPLARY EMBODIMENTS

Hereinafter, exemplary embodiments of the present disclosure and properties of individual components are described in detail so that the disclosure may be easily performed by those skilled in the art to which the present disclosure belongs, but are not to be construed as limiting the spirit and scope of the present disclosure.

The present disclosure addresses a coating composition for protecting a metal surface, comprising styrene-ethylene-butylene-styrene rubber, a solvent and an additive, and preferably, the amount of styrene-ethylene-butylene-styrene rubber is 100 parts by weight, the amount of the solvent is 325 to 475 parts by weight and the amount of the additive is 2.5 to 25 parts by weight.

The styrene-ethylene-butylene-styrene (SEBS) rubber is contained as a main material in the disclosed coating composition, and is configured such that styrene-butadiene rubber is hydrogenated so that the carbon-carbon double bond of butadiene in the styrene-butadiene rubber molecule is converted into a carbon-carbon single bond. This functions to prevent the metal surface from scratching or corroding.

Also, the styrene-ethylene-butylene-styrene rubber does not contain a carbon-carbon double bond that reacts with oxygen in the air, and thus may exhibit stable properties even without the use of an oxidative decomposition inhibitor. It has high peeling capability compared to styrene-butadiene rubber, and aging of the coating film does not readily progress even after the lapse of a long period of time following the coating process, thus preventing the tearing of the coating film during the peeling of the coating film, whereby the coating film may be easily removed from the metal surface.

If the amount of the styrene-ethylene-butylene-styrene rubber is less than 100 parts by weight, the resulting coating film becomes too thin, thus deteriorating the metal surface protection effect of the coating film. On the other hand, if the amount of the styrene-ethylene-butylene-styrene rubber exceeds 100 parts by weight, the viscosity of the coating solution is excessively increased, making it difficult to form a coating film having a uniform thickness.

The solvent is contained in an amount of 325 to 475 parts by weight, may include at least one selected from the group consisting of toluene, xylene and methyl ethyl ketone, and functions to dissolve the styrene-ethylene-butylene-styrene rubber so as to form a coating film having a uniform thickness and homogeneous properties.

The solvent may be used in various combinations of the above solvent components depending on need. Specifically, toluene is preferably used during the application of the coating composition of the disclosure, like typical paint, xylene is preferably used in a spraying process, and methyl ethyl ketone or a mixture of toluene and methyl ethyl ketone may be used in lieu of toluene in a process that requires rapid drying. Furthermore, xylene or a mixture of toluene and xylene may be used when there is a need to decrease the drying rate.

If the amount of the solvent is less than 325 parts by weight, the viscosity of the coating composition is too high, making it difficult to form a coating film having a uniform thickness on the metal surface. On the other hand, if the amount of the solvent exceeds 475 parts by weight, the viscosity of the coating solution is too low, and thus the coating solution may flow down during the coating process, which is undesirable. Furthermore, the resulting coating film becomes too thin, and thus effects of protecting the metal surface from scratching or corroding may become insignificant.

The additive is contained in an amount of 2.5 to 25 parts by weight, and includes a colorant and a defoaming agent, and preferably, the colorant has the amount of 100 parts by weight and the defoaming agent has the amount of 120 to 400 parts by weight.

The color of the colorant is not particularly limited, and various kinds of colorants may be used so long as the coating composition of the disclosure may be colored therewith, and the component of the defoaming agent is not particularly limited, and any defoaming agent may be used so long as it is able to inhibit the foaming of the coating composition.

Based on 100 parts by weight of the styrene-ethylene-butylene-styrene rubber, the coating composition of the disclosure may further include 20 to 35 parts by weight of a UV blocker containing titanium dioxide. The UV blocker functions to impart opaqueness to the coating composition and to prevent the coating film made of the coating composition from deteriorating due to UV light.

If the amount of the UV blocker is less than 20 parts by weight, the above effects are insignificant. On the other hand, if the amount of the UV blocker exceeds 35 parts by weight, the above effects are not greatly improved, and the manufacturing cost is increased.

Also, based on 100 parts by weight of the styrene-ethylene-butylene-styrene rubber, the coating composition of the disclosure may further include 85 to 100 parts by weight of a swelling inhibitor containing dimethylether, the swelling inhibitor functioning to inhibit the swelling of the styrene-ethylene-butylene-styrene rubber so as to form a coating film having a uniform thickness.

If the amount of the swelling inhibitor is less than 85 parts by weight, the above effects are insignificant. On the other hand, if the amount of the swelling inhibitor exceeds 100 parts by weight, the relative amounts of the styrene-ethylene-butylene-styrene rubber, solvent, and additive may decrease, thus deteriorating the properties of the coating film made of the coating composition.

A better understanding of the present disclosure regarding the method of preparing the coating composition for protecting a metal surface and the properties of the coating composition prepared thereby may be obtained through the following Examples.

### Example 1

25 g of styrene-ethylene-butylene-styrene rubber and 73 g of toluene were placed in a 250 ml flask, whereby the styrene-ethylene-butylene-styrene rubber was dissolved in toluene, after which the resulting solution was placed in a stirrer together with 2 g of a blue colorant and 2.5 g of a defoaming agent and was then stirred at 200 rpm for 10 min, thus preparing a coating composition for protecting a metal surface.

### Comparative Example 1

A coating composition for protecting a metal surface was prepared in the same manner as in Example 1, with the exception that styrene-butadiene rubber was used in lieu of the styrene-ethylene-butylene-styrene rubber.

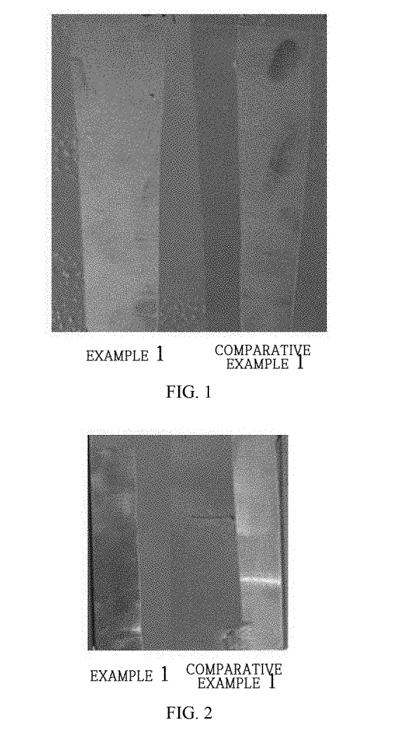

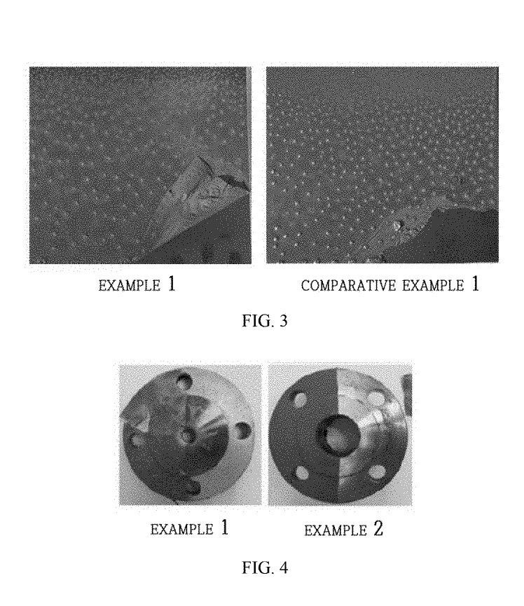

The coating composition of each of Example 1 and Comparative Example 1 was applied to a thickness of 0.1 mm on the surface of an iron plate, and the removal efficiency of the coating film over time was measured. The results are shown in Table 1 below and FIGS. 1 to 3.

(The removal efficiency of the coating film was measured in a manner in which the coating composition was applied and the coating film was pulled with a consistent force using a peeling tester, after which the state of the coating film was observed with the naked eye.)

TABLE 1

| | Duration | | |
|---|---|---|---|
| No. | 24 hr | 1 week | 30 days |
| Example 1 | Normal | Normal | Normal |
| Comparative | Normal | Partial tearing of coating | Cutting of coating film |
| Example 1 | | film | |

As is apparent from Table 1 and FIG. 2, the coating film formed of the coating composition of Example 1 was neither torn nor cut during the removal process after a long period of time, but the coating film formed of the coating composition of Comparative Example 1 was partially torn after one week, and was cut after one month.

### Example 2

15 g of styrene-ethylene-butylene-styrene rubber and 83 g of xylene were placed in a 250 ml flask, whereby the styrene-ethylene-butylene-styrene rubber was dissolved in xylene, after which the resulting solution was placed in a stirrer together with 2 g of a blue colorant and 2.5 g of a defoaming agent and was then stirred at 200 rpm for 10 min, thus preparing a coating composition for protecting a metal surface.

### Comparative Example 2

A coating composition for protecting a metal surface was prepared in the same manner as in Example 2, with the exception that styrene-butadiene rubber was used in lieu of the styrene-ethylene-butylene-styrene rubber.

The coating composition of each of Example 2 and Comparative Example 2 was placed in a 350 ml spray can together with 120 g of a dimethylether propellant, and was applied through spray coating to a thickness of 0.1 mm on the surface of an iron plate, and the removal efficiency of the coating film over time was measured. The results are shown in Table 2 below.

(The removal efficiency of the coating film was measured in a manner in which the coating composition was applied and the coating film was pulled with a consistent force using a peeling tester, after which the state of the coating film was observed with the naked eye.)

TABLE 2

| | Duration | | |
|---|---|---|---|
| No. | 24 hr | 1 week | 30 days |
| Example 2 | Normal | Normal | Normal |
| Comparative | Normal | Cutting of coating film | Cutting of coating |
| Example 2 | | | film |

As is apparent from Table 2, the coating film formed of the coating composition of Example 2 was neither torn nor cut during the removal process after a long period of time.

In addition, the metal coated with the coating composition of each of Examples 1 and 2 was subjected to salt spray testing. The results are shown in FIG. 4.

(Salt Spray Testing was Performed in Accordance with KS D 9502.)

As shown in FIG. 4, the metal coated with the coating composition of each of Examples 1 and 2 exhibited superior corrosion resistance.

Therefore, the disclosed coating composition can inhibit scratching or corrosion when applied on the surface of a metal such as a flange and is effective at enabling easy peeling of a coating film even when the coating film is intended to be peeled in order to perform a welding process or the like, and moreover, the resultant coating film does not tear but is easily peeled even when removed after long-term storage.

Although the exemplary embodiments of the present disclosure have been disclosed for illustrative purposes with reference to the accompanying drawings, those skilled in the art will appreciate that various modifications and equivalents are possible, without departing from the scope and spirit of the present disclosure as disclosed in the accompanying claims.

What is claimed is:

1. A coating composition for protecting a metal surface, comprising styrene-ethylene-butylene-styrene rubber, a solvent and an additive.

2. The coating composition of claim 1, wherein the amount of the styrene-ethylene-butylene-styrene rubber is 100 parts by weight, the amount of the solvent is 325 to 475 parts by weight and the amount of the additive is 2.5 to 25 parts by weight.

3. The coating composition of claim 1, wherein the solvent comprises at least one selected from the group consisting of toluene, xylene and methyl ethyl ketone.

4. The coating composition of claim 1, wherein the additive comprises a colorant and a defoaming agent.

5. The coating composition of claim 1, wherein based on 100 parts by weight of the styrene-ethylene-butylene-styrene rubber, the coating composition further comprises 20 to 35 parts by weight of a UV blocker containing titanium dioxide.

6. The coating composition of claim 1, wherein based on 100 parts by weight of the styrene-ethylene-butylene-styrene rubber, the coating composition further comprises 85 to 100 parts by weight of a swelling inhibitor containing dimethylether.
